(19) United States
(12) Patent Application Publication
(10) Pub. No.: US 2018/0257086 A1
(43) Pub. Date: Sep. 13, 2018

(54) WEIGHT SENSING INTEGRATED BRUISING-SIEVING MACHINE FOR AUTOMATED TEA PROCESSING

(71) Applicant: Chi Lai YEUNG, Hong Kong (HK)

(72) Inventor: Chi Lai YEUNG, Hong Kong (HK)

(21) Appl. No.: 15/496,189

(22) Filed: Apr. 25, 2017

(30) Foreign Application Priority Data
Mar. 8, 2017 (CN) 201710135575.8

(51) Int. Cl. B02C 25/00; A23F 3/06; B02C 23/10; B02C 18/06; B02C 18/18

(52) U.S. Cl. CPC B02C 25/00; A23F 3/06; B02C 18/18; B02C 18/06; B02C 23/10

(57) ABSTRACT

The weight sensing integrated bruising-sieving machine for automated tea processing of the present invention comprises a frame, a bruiser device mounted on the frame, a sieving device and a PLC controller. The bruiser device comprises a bruiser disc, a number of bruiser blades, a first motor mounted on the frame, two pressure adjustment springs, and an adjustment bolt disposed on a first motor main axis. The bruiser disc is mounted on the frame through a number of supporter plates. The sieving device is disposed below the bruiser device. The sieving device comprises a second motor, a pair of crank mechanisms, a sieve, a sleeve for directing unloading of tea leaves, and an electrically actuated cylinder. An end of the sieve is interdrivably connected to the second motor through the crank mechanism, another end of the sieve is interconnected to an end of the electrically actuated cylinder through the crank mechanism. The structure of the weight sensing integrated bruising-sieving machine for automated tea processing of the present invention is sensible, simple, convenient to use, efficient and highly automated, effectively solving the problem of low efficiency and low degree of automation of traditional tea bruising machines

### FIELD OF INVENTION

The present invention relates to the field of tea processing machines, in particular to a weight sensing integrated bruising-sieving machine for automated tea processing.

### BACKGROUND OF INVENTION

Bruising is a very important step in initial processing of tea leaves, the result of the bruising step is a deciding factor in the quality of the tea. Traditional tea bruising machines are mainly made up of bruiser bucket, a press lid and a bruiser disc. Tea leaves are poured into the bruiser bucket from above and, using a crank mechanism, driving the bruiser bucket to undergo lateral rotating movement on the bruiser disc. Under the forces from the bruiser bucket, the press lid, the bruiser disc, ribs and the tea leaves itself, tea leaves are rolled into strips along the main vein of the leaves, and at the same time breaking down the leaf cells. The bruised leaves are unloaded through a gate at the center of the bruiser disc, completing the bruising process. Such machine only utilizes an area having the same size as the bottom of the bruiser bucket during operation, therefore utilization rate and the bruising efficiency is low. Furthermore, tea leaves have to be manually removed from the bruiser bucket from above after bruising, which is a cumbersome process. Ashes or residue produced during bruising process need to be filtered at a later stage, making the process even more cumbersome.

### SUMMARY OF INVENTION

The technical problem to be solved by the present invention is: to overcome the aforementioned problem, a weight sensitive integrated bruising-sieving machine for automated tea processing is provided. The structure of the device is sensible, simple, convenient to use, efficient and highly automated, effectively solving the problem of low efficiency and low degree of automation of traditional tea bruising machines.

The technical solution used in the present invention to solve the technical problem is: a weight sensing integrated bruising-sieving machine for automated tea processing, comprising a frame, a bruiser device disposed on the frame, a sieving device and a PLC controller. The bruiser device comprises a bruiser disc, a number of bruiser blades, a first motor mounted on the frame, two pressure adjustment springs, and an adjustment bolt disposed on a first motor main axis. The two pressure adjustment springs are inserted onto the first motor main axis. The bruiser blades are inserted onto the first motor main axis between the two pressure adjustment springs, and is further longitudinally slidably interconnected with a slide rail disposed along the first motor main axis through a sliding block disposed on the bruiser blades. The bruiser disc is mounted on the frame through a number of supporter plates, the bruiser disc having a beveled edge.

The sieving device is disposed below the bruiser device. The sieving device comprises a second motor, a pair of crank mechanisms, a sieve, a sleeve for directing unloading of tea leaves, and an electrically actuated cylinder. A weight sensor for detecting a weight of tea leaves loaded on the sieve is disposed at a connection joint between the crank mechanism and the sieve. The second motor is mounted on a motor stand, and the motor stand is hinged to the frame. An end of the sieve is interdrivably connected to the second motor through the crank mechanism, another end of the sieve is interconnected to an end of the electrically actuated cylinder through the crank mechanism. Another end of the electrically actuated cylinder is hinged to the frame.

In a preferred embodiment, a cylindrical blocker plate is disposed on the frame for prevent tea from spilling out.

In a preferred embodiment, curved rib is disposed on the bruiser disc.

In a preferred embodiment, the sliding block is integrated to the bruiser blades.

In a preferred embodiment, fiber bristles are disposed on the bruiser blades.

In a preferred embodiment, a ring groove is disposed between the bruiser disc and the frame for unloading.

In a preferred embodiment, a humidity sensor is disposed on the sieve.

In a preferred embodiment, the PLC controller is mounted on the frame, the PLC controller is electrically connected to the first motor, the second motor, the weight sensor and the humidity sensor.

In a preferred embodiment, a residue collector is disposed below the sieve.

The advantage of the present invention is: the weight sensing integrated bruising-sieving machine for automated tea processing of the present invention comprises a frame, a bruiser device mounted on the frame, a sieving device and a PLC controller. The bruiser device uses bruiser blades radially disposed above the bruiser disc to replace the bruiser bucket, significantly improving the utilization rate of the bruiser plate and bruising efficiency. Under the effect of the curved ribs and the bruiser blades, tea leaves are pushed towards the inside of the bruiser disc when the first motor is rotating in the clockwise direction. When the first motor is rotating in the opposite direction, the tea leaves move towards the perimeter of the bruiser disc, and fall into the sieving device through the ring groove of the bruiser disc, eliminating the need of removing the tea from the bruiser bucket. The sieving device is driven by the second motor, and has a weight sensor, a humidity sensor and an electrically actuated cylinder disposed. The sieve can automatically pour the sieved tea leaves under the drive of the electrically actuated cylinder, increasing the automation level of the machine. The structure of the device is sensible, simple, convenient to use, efficient and highly automated, effectively solving the problem of low efficiency and low degree of automation of traditional tea bruising machines.

### BRIEF DESCRIPTION OF DRAWINGS

The present invention is further explained below with the accompanying drawings and embodiments.

FIG. 1 is an overall structural schematic diagram of a weight sensing integrated bruising-sieving machine for automated tea processing according to the present invention.

FIG. 2 is a structural schematic diagram of a connection mechanism between a bruising disc and a frame of a weight sensing integrated bruising-sieving machine for automated tea processing according to the present invention.

FIG. 3 is a structural schematic diagram of a connection mechanism between bruising blades and a main axis of a first motor of a weight sensing integrated bruising-sieving machine for automated tea processing according to the present invention.

FIG. 4 is a structural schematic diagram of a connection mechanism between a second motor and a motor stand and a frame of a weight sensing integrated bruising-sieving machine for automated tea processing according to the present invention.

Reference numbers in the drawings: 1 frame, 11 cylindrical blocking plate, 2 bruiser device, 21 bruiser disc, 211 supporter plate, 212 bevel edge, 213 curved rib, 214 ring groove, 22 bruiser blade, 220 fiber bristle, 221 sliding block, 23 first motor, 231 first motor main axis, 232 slide rail, 24 pressure adjustment spring, 25 adjustment bolt, 3 sieving device, 31 second motor, 311 motor stand, 32 crank mechanism, 33 sieve, 34 sleeve, 35 electrically actuated cylinder, 36 weight sensor, 37 residue collector, 38 humidity sensor, 4 PLC controller.

### DETAILED DESCRIPTION OF INVENTION

The present invention is further explained below along with the accompanying drawings. The drawings are all simplified schematic diagrams which only illustrates the basic structure of the present invention, as such only the components material to the present invention are shown.

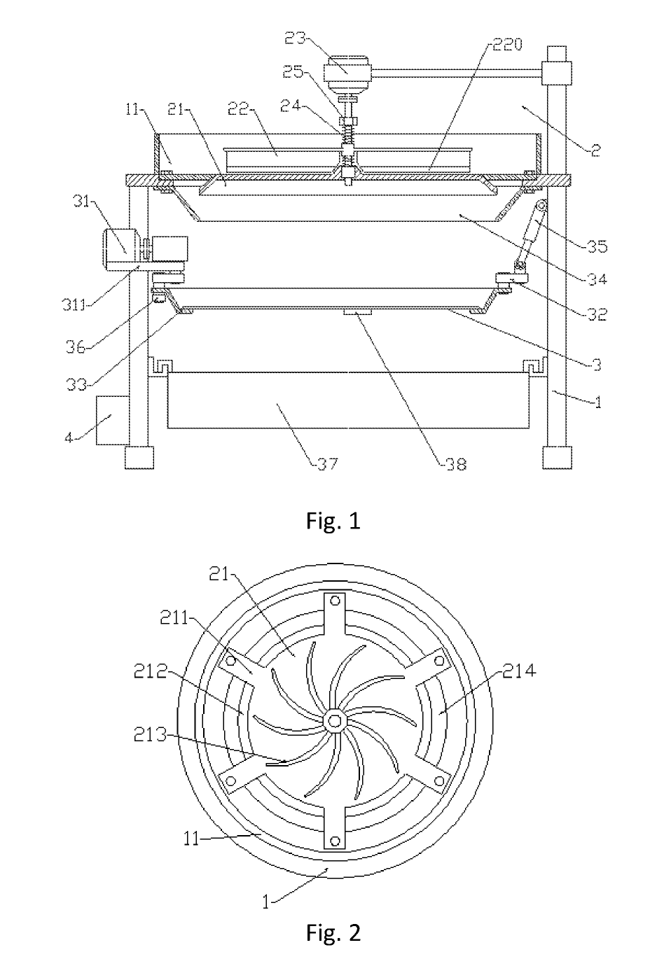

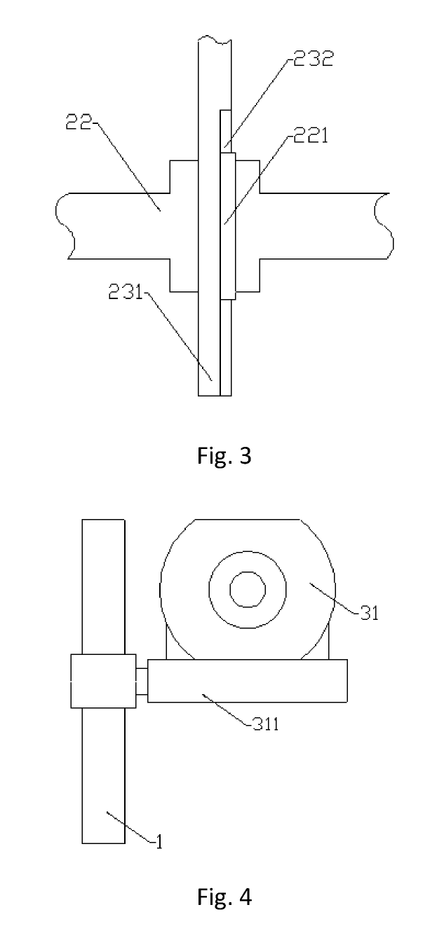

A weight sensing integrated bruising-sieving machine for automated tea processing is shown in FIGS. 1-4. The machine comprises a frame 1, a bruiser device 2 disposed on the frame 1, a sieving device 3, and a PLC controller 4. The bruiser device 2 comprises a bruiser disc 21, a number of bruiser blades 22, a first motor disposed on the frame 1, two pressure adjustment springs 24, and an adjustment bolt 25 disposed on a first motor main axis 231. The two pressure adjustment springs 24 are inserted onto the first motor main axis 231, and are slidably connected to a slide rail 232 disposed on the first motor main axis 231 through a sliding block 221 disposed on the bruiser blades 22. The bruiser disc 21 is mounted on the frame 1 using a number of supporter plates 211, a bevel edge 212 is further disposed on the bruiser disc 21.

The sieving device 3 is disposed below the bruiser device 2. The sieving device 3 comprises a second motor 31, a pair of crank mechanisms 32, a sieve 33, a sleeve 34 for directing unloading of tea leaves, and an electrically actuated cylinder 35. A weight sensor 36 for detecting a weight of tea leaves loaded on the sieve 33 is disposed at a connection joint between the crank mechanism 32 and the sieve 33. The second motor 31 is mounted on a motor stand 311, the motor stand 311 is hinged to the frame 1. An end of the sieve 33 is interdrivably connected to the second motor 31 through the crank mechanism 32, another end of the sieve 33 is interconnected to the electrically actuated cylinder 35 through the crank mechanism. Another end of the electrically actuated cylinder 35 is hinged to the frame 1.

A cylindrical blocker plate 11 is disposed on the frame 1 to prevent tea leaves from spilling out. Curved ribs 213 are disposed on the bruiser disc 21. The sliding block 221 is integrated to the bruiser blades 22. Fiber bristles 220 is disposed on the bruiser blades 22. A ring groove 214 is disposed between the bruiser disc 21 and the frame 1 for unloading. A humidity sensor 38 is disposed on the sieve 33. The PLC controller 4 is mounted on the frame 1, and the PLC controller 4 is electrically connected to the first motor 23, the second motor 31, the weight sensor 36 and the humidity sensor 38. A residue collector 37 is disposed below the sieve 33.

The weight sensing integrated bruising-sieving machine for automated tea processing of the present invention comprises a frame, a bruiser device mounted on the frame, a sieving device and a PLC controller. The bruiser device uses bruiser blades radially disposed above the bruiser disc to replace a bruiser bucket, significantly improving the utilization rate of the bruiser plate and bruising efficiency. Under the effect of the curved ribs and the bruiser blades, tea leaves are pushed towards the inside of the bruiser disc when the first motor is rotating in the clockwise direction. When the first motor is rotating in the opposite direction, the tea leaves move towards the perimeter of the bruiser disc, and fall into the sieving device through the ring groove of the bruiser disc, eliminating the need of removing the tea from the bruiser bucket. The sieving device is driven by the second motor, and has a weight sensor, a humidity sensor and an electrically actuated cylinder disposed. The sieve can automatically pour the sieved tea leaves under the drive of the electrically actuated cylinder, increasing the automation level of the machine. The structure of the device is sensible, simple, convenient to use, efficient and highly automated, effectively solving the problem of low efficiency and low degree of automation of traditional tea bruising machines.

As revealed by the preferred embodiments of the present invention, based on the aforementioned description, a person skilled in the art can make various modifications and adjustments without departing from the technical concept of the present invention. The technical scope of the present invention is not limited to the specification but is defined by the scope of the claims.

What is claimed is:

1. A weight sensing integrated bruising-sieving machine for automated tea processing, comprising a frame, a bruiser device disposed on the frame, a sieving device and a PLC controller; the bruiser device comprises a bruiser disc, a number of bruiser blades, a first motor mounted on the frame, two pressure adjustment springs, and an adjustment bolt disposed on a first motor main axis; the two pressure adjustment springs are inserted onto the first motor main axis; the bruiser blades are inserted onto the first motor main axis between the two pressure adjustment springs, and is further longitudinally slidably interconnected with a slide rail disposed along the first motor main axis through a sliding block disposed on the bruiser blades; the bruiser disc is mounted on the frame through a number of supporter plates, the bruiser disc having a beveled edge;
the sieving device is disposed below the bruiser device; the sieving device comprises a second motor, a pair of crank mechanisms, a sieve, a sleeve for directing unloading of tea leaves, and an electrically actuated cylinder; a weight sensor for detecting a weight of tea leaves loaded on the sieve is disposed at a connection joint between the crank mechanism and the sieve; the second motor is mounted on a motor stand, and the motor stand is hinged to the frame; an end of the sieve is interdrivably connected to the second motor through the crank mechanism, another end of the sieve is interconnected to an end of the electrically actuated cylinder through the crank mechanism; another end of the electrically actuated cylinder is hinged to the frame.

2. The weight sensing integrated bruising-sieving machine for automated tea processing according to claim 1, characterized in that: a cylindrical blocker plate is disposed on the frame for prevent tea from spilling out.

3. The weight sensing integrated bruising-sieving machine for automated tea processing according to claim 1, characterized in that: curved rib is disposed on the bruiser disc.

4. The weight sensing integrated bruising-sieving machine for automated tea processing according to claim 1, characterized in that: the sliding block is integrated to the bruiser blades.

5. The weight sensing integrated bruising-sieving machine for automated tea processing according to claim 1, characterized in that: a ring groove is disposed between the bruiser disc and the frame for unloading.

6. The weight sensing integrated bruising-sieving machine for automated tea processing according to claim 1, characterized in that: fiber bristles are disposed on the bruiser blades.

7. The weight sensing integrated bruising-sieving machine for automated tea processing according to claim 1, characterized in that: a humidity sensor is disposed on the sieve.

8. The weight sensing integrated bruising-sieving machine for automated tea processing according to claim 1, characterized in that: the PLC controller is mounted on the frame, the PLC controller is electrically connected to the first motor, the second motor, the weight sensor and the humidity sensor.

9. The weight sensing integrated bruising-sieving machine for automated tea processing according to claim 1, characterized in that: a residue collector is disposed below the sieve.
